(19) United States
(12) Patent Application Publication
(10) Pub. No.: US 2015/0256552 A1
(43) Pub. Date: Sep. 10, 2015

(54) IMALICIOUS CODE DETECTION APPARATUS AND METHOD

(71) Applicant: ELECTRONICS AND TELECOMMUNICATIONS RESEARCH INSTITUTE, DAEJEON (KR)

(72) Inventors: Sang Rok LEE, Daejeon (KR); Cheol Ho LEE, Daejeon (KR); In Sook JANG, Daejeon (KR); Jung Sun KIM, Daejeon (KR); Jung Min KANG, Daejeon (KR)

(21) Appl. No.: 14/470,726

(22) Filed: Aug. 27, 2014

(30) Foreign Application Priority Data
Mar. 4, 2014 (KR) 10-2014-0025542

(51) Int. Cl. H04L 29/06; G06F 21/55

(52) U.S. Cl. CPC H04L 63/1416; G06F 21/554

(57) ABSTRACT

Disclosed herein is a malicious code detection apparatus and method, which detect malicious code based on the states of a system before and after a malicious code sample is executed. A state of a sample execution system before a malicious code sample is executed. Static analysis and dynamic analysis of the malicious code sample are performed. After the malicious code sample has been executed, a state of the sample execution system is extracted, the results of extraction of the state are compared with results of extraction of the state of the sample execution system before the malicious code sample is executed, and change information of the system is acquired. It is detected whether malicious behavior of the malicious code sample has been conducted, using static analysis information and dynamic analysis information corresponding to results of performing static analysis and dynamic analysis and the system change information.

### CROSS REFERENCE TO RELATED APPLICATION

This application claims the benefit of Korean Patent Application No. 10-2014-0025542, filed Mar. 4, 2014, which is hereby incorporated by reference in its entirety into this application.

### BACKGROUND OF THE INVENTION

1. Technical Field

The present invention relates generally to a malicious code detection apparatus and method and, more particularly, to an apparatus and method that detect malicious code based on the states of a system before and after a malicious code sample is executed.

2. Description of the Related Art

In the past, malicious code was detected using a static analysis method and a dynamic analysis method (or behavior-based analysis method).

A static analysis method may analyze and detect malicious codes via a procedure for determining whether a header has been forged in an execution file, a procedure for determining whether a file extension or a file format has been forged, or a procedure for searching the file for a suspicious character string.

A dynamic analysis method is a method of tracking and recording system calls (Application Programming Interface: API) corresponding to a file, a registry, a process, and a network after the execution of malicious code, and then analyzing the behavior of the malicious code.

For example, Korean Patent Application Publication No. 2013-0077621 entitled “Apparatus and method for providing dynamic analysis information for malicious code” proposes dynamic malicious code analysis technology for dynamically analyzing malicious code based on a point at which a malicious code operation is called, so that the occurrence of malicious code can be monitored in a situation in which debugging is not performed and the code of a program in which the malicious code has occurred can be identified, thus performing debugging at the point in time desired by an analyzer.

In particular, a conventional behavior-based analysis method is an analysis method for imposing the levels of threat on respective system calls, or forming system call groups and imposing the levels of threat on the respective groups, and is problematic in that when system calls to be monitored are intentionally bypassed, it is difficult to detect malicious code.

In this way, the conventional analysis method is limited in that, after detected malicious code has been analyzed, the characteristics of analyzed static or dynamic behavior are used again as detection technology. In this case, when new malicious code does not use a well-known existing scheme, a problem arises in that it may be impossible to detect malicious code using a conventional analysis method.

### SUMMARY OF THE INVENTION

Accordingly, the present invention has been made keeping in mind the above problems occurring in the prior art, and a first object of the present invention is to provide a malicious code detection apparatus and method, which can detect malicious behavior when malicious code conducts a new type of malicious behavior without using conventional well-known static patterns and dynamic patterns.

A second object of the present invention is to provide a malicious code detection apparatus and method, which compare and analyze the state of a system after malicious code has been executed with the state of the system before the malicious code is executed, thus determining whether malicious behavior has been conducted.

A third object of the present invention is to provide a malicious code detection apparatus and method, which can extract the states of a system from the inside of the system (in-system configuration) and from the outside of the system (out-of-system configuration).

A fourth object of the present invention is to provide a malicious code detection apparatus and method, which can perform state-based analysis using the volatile state (memory) and non-volatile state (disk) of a system, and the state of a network.

A fifth object of the present invention is to provide a malicious code detection apparatus and method, which can analyze and detect whether a malicious code sample has conducted malicious behavior, even in a real environment as well as in a virtual environment.

A sixth object of the present invention is to provide a malicious code detection apparatus and method, which enable malicious code, concealed via the rebooting of a system, the execution of a specific program, the falsification of system time, or the like, to be executed on the system, thus enabling the malicious code to be detected.

A seventh object of the present invention is to provide a malicious code detection apparatus and method, which can calculate the level of threat by associating the individual state change items of the system with information about whether malicious behavior has been conducted.

In accordance with an aspect of the present invention to accomplish the above objects, there is provided a malicious code detection method, including extracting a state of a sample execution system before a malicious code sample is executed; performing static analysis and dynamic analysis of the malicious code sample; after the malicious code sample has been executed, extracting a state of the sample execution system, comparing the results of extraction of the state with results of extraction of the state of the sample execution system before the malicious code sample is executed, and acquiring change information of the system; and detecting whether malicious behavior of the malicious code sample has been conducted, using static analysis information and dynamic analysis information corresponding to results of performing static analysis and dynamic analysis and the system change information.

Extracting the state of the sample execution system may include extracting an internal state of the sample execution system; and extracting, from outside of the sample execution system, an external state of the sample execution system without operating in conjunction with an operating system.

Extracting the external state may include when the sample execution system is operated on a virtual machine, extracting the external state using a virtual machine file analysis method based on forensics for a memory file and a disk file of the virtual machine and a system state extraction method of operating in conjunction with a virtual machine management layer.

Extracting the state of the sample execution system may include extracting state information including at least one of a list of execution processes and a list of library modules loaded for respective processes; a running kernel driver; pieces of network connection and data information for respective processes executed after booting of the system; a list of important operating system files, and hash and digital signature information; virtual memory descriptor information; memory maps of respective processes; kernel data; registry hives; and an execution service or a daemon.

Performing the static analysis and the dynamic analysis may include performing static analysis by determining whether a header in an execution file has been forged, whether a file extension or format has been forged, or whether the file has been searched for a suspicious character string, in a state in which the malicious code sample is present as a file in a disk without the malicious code sample being executed.

Performing the static analysis and the dynamic analysis may include, after the malicious code sample has been executed, tracking and recording kernel data corresponding to a file, a registry, a process, and a network that are called while the malicious code sample is operating in the sample execution system, and then performing dynamic analysis.

Detecting whether the malicious behavior of the malicious code sample has been conducted may include calculating a level of threat of the malicious code sample using the static analysis information, the dynamic analysis information, and the system change information, and detecting whether malicious behavior of the malicious code sample has been conducted, based on the calculated level of threat.

In accordance with another aspect of the present invention to accomplish the above objects, there is provided a malicious code detection apparatus, including an extraction unit for extracting a state of a sample executing system before a malicious code sample is executed; an analysis unit for performing static analysis and dynamic analysis of the malicious code sample; and a determination unit for comparing results of extraction of a state of the sample execution system after the malicious code sample has been executed, with results of extraction of the state of the sample execution system before the malicious code sample is executed, acquiring change information of the system, and detecting whether malicious behavior of the malicious code sample has been conducted, using results of analysis by the analysis unit and the system change information.

The extraction unit may include an internal state extraction unit for extracting an internal state of the sample execution system; and an external state extraction unit for extracting, from outside of the sample execution system, an external state of the sample execution system without operating in conjunction with an operating system.

The external state extraction unit may be configured to, when the sample execution system is operated on a virtual machine, extract the external state using a virtual machine file analysis method based on forensics for a memory file and a disk file of the virtual machine and a system state extraction method of operating in conjunction with a virtual machine management layer.

The extraction unit may extract state information including at least one of a list of execution processes and a list of library modules loaded for respective processes; a running kernel driver; pieces of network connection and data information for respective processes executed after booting of the system; a list of important operating system files, and hash and digital signature information; virtual memory descriptor information; memory maps of respective processes; kernel data; registry hives; and an execution service or a daemon

The analysis unit may include a static analysis unit for performing static analysis by determining whether a header in an execution file has been forged, whether a file extension or format has been forged, or whether the file has been searched for a suspicious character string, in a state in which the malicious code sample is present as a file in a disk without the malicious code sample being executed.

The analysis unit may include a dynamic analysis unit for, after the malicious code sample has been executed, tracking and recording kernel data corresponding to a file, a registry, a process, and a network that are called while the malicious code sample is operating in the sample execution system, and then performing dynamic analysis.

The determination unit may use a malicious behavior determination criterion corresponding to at least one of registration as an initial execution process, installation of a rootkit, registration as an initial execution kernel driver, and collection of malicious commands via automatic network connection, upon comparing the results of extraction of the state of the sample execution system after the malicious code sample has been executed, with the results of extraction of the state of the sample execution system before the malicious code sample is executed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an environment to which a malicious code detection apparatus according to an embodiment of the present invention is applied;

FIG. 2 is a configuration diagram schematically showing a malicious code detection apparatus according to an embodiment of the present invention;

FIG. 3 is a reference diagram showing a method of extracting the state of a sample execution system before a malicious code sample is executed according to an embodiment of the present invention;

FIG. 4 is a reference diagram showing a method of extracting the state of the sample execution system on which the malicious code sample is currently being executed according to an embodiment of the present invention;

FIG. 5 is a reference diagram showing a method of extracting the state of the sample execution system after the malicious code sample has been executed according to an embodiment of the present invention; and

FIG. 6 is a flowchart showing a malicious code detection method according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

Hereinafter, an apparatus and method for detecting malicious code based on the states of a system before and after a malicious code sample is executed according to embodiments of the present invention will be described in detail with reference to the attached drawings.

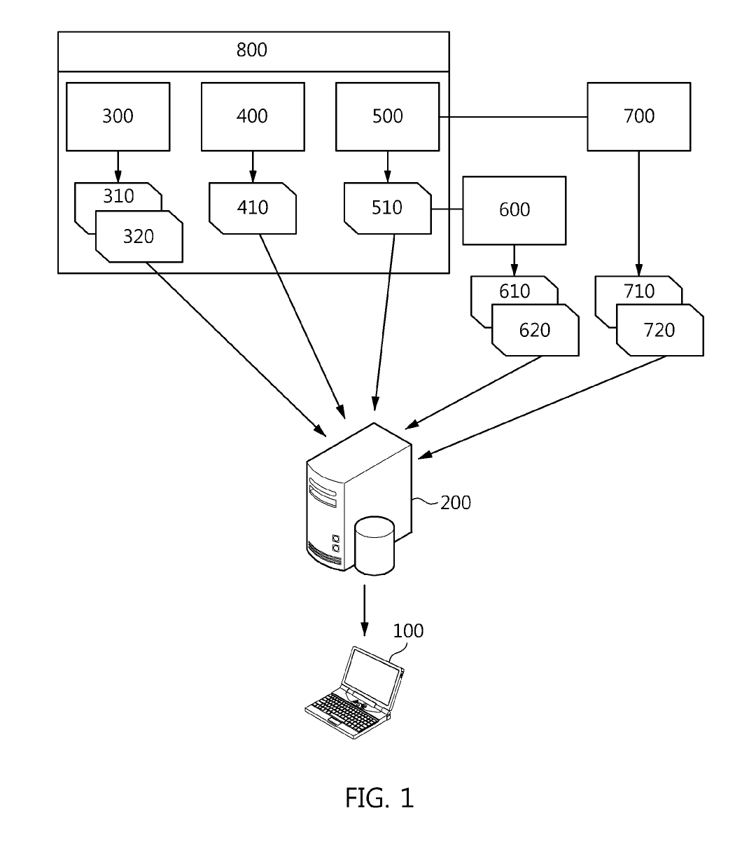

FIG. 1 is a diagram showing an environment to which a malicious code detection apparatus according to an embodiment of the present invention is applied.

Referring to FIG. 1, a malicious code detection environment according to the embodiment of the present invention includes a user terminal 100, a malicious code detection apparatus 200, and a sample execution system 800.

The malicious code detection apparatus 200 performs, under the control of the user of the user terminal 100, a procedure for acquiring the state of the sample execution system 800 before a malicious code sample is executed, a procedure for performing static analysis and dynamic analysis of the malicious code sample, and a procedure for calculating the level of threat of the malicious code sample using the static and dynamic analysis information acquired via the static and dynamic analysis procedure, and change items in the results of extraction of the state of the sample execution system 800 after the malicious code sample has been executed, and for detecting whether the behavior of the malicious code has been conducted.

For this operation, a state analysis tool 300, a static analysis tool 400, and a dynamic analysis tool 500 may be located in the sample execution system 800 (in-system configuration), but the configuration of the present invention is not limited thereto. The state analysis tool 300 generates the state files 310 and 320 of the sample execution system 800. Further, the static analysis tool 400 generates the static analysis result file 410 of the sample execution system 800. The dynamic analysis tool 500 generates the dynamic analysis result file 510 of the sample execution system 800.

A volatile state analysis tool 600 and a non-volatile state analysis tool 700 are located out of the sample execution system 800 (out-of-system configuration). The volatile state analysis tool 600 extracts the volatile state file 610 of the sample execution system 800 before the sample is executed, and the volatile state file 620 of the sample execution system 800 after the sample has been executed. Further, the non-volatile state analysis tool 700 extracts the non-volatile state file 710 of the sample execution system 800 before the sample is executed, and the non-volatile state file 720 of the sample execution system 800 after the sample has been executed.

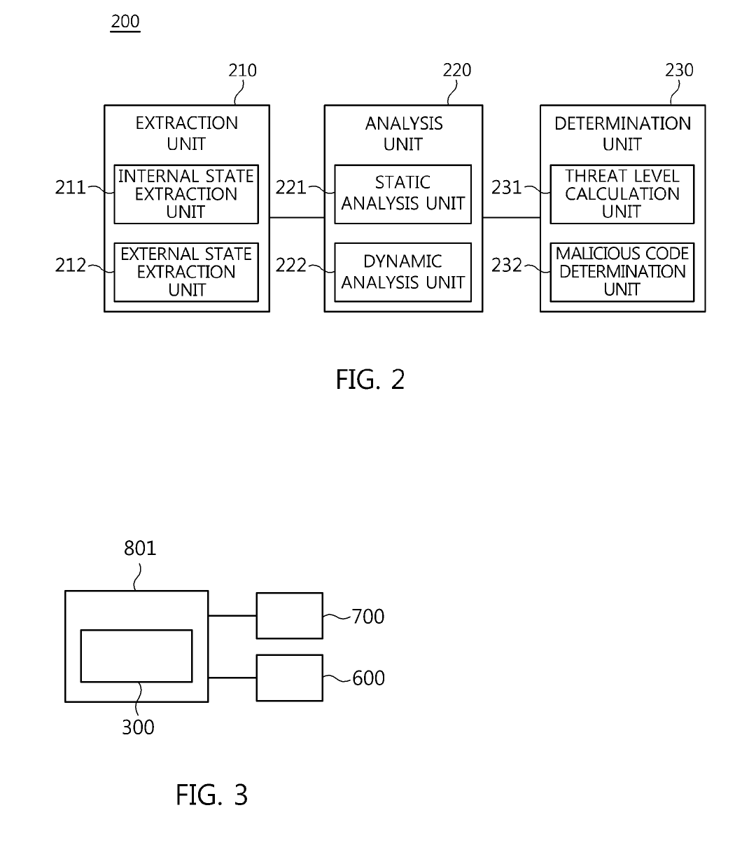

Below, the malicious code detection apparatus 200 will be described in detail with reference to FIG. 2.

FIG. 2 is a configuration diagram schematically showing a malicious code detection apparatus according to an embodiment of the present invention.

Referring to FIG. 2, the malicious code detection apparatus 200 includes an extraction unit 210, an analysis unit 220, and a determination unit 230.

The extraction unit 210 extracts the state of a sample execution system 800 before a malicious code sample is executed. For this, the extraction unit 210 includes an internal state extraction unit 211 for executing the internal state of a system such as the sample execution system 800 and an external state extraction unit 212 for extracting the external state of the system.

The internal state extraction unit 211 includes a state extractor (not shown) for operating in conjunction with an operating system, in the system, and may extract internal state information using the state extractor.

The internal state information extracted by the internal state extraction unit 211 includes state information that can be read from the inside of the system during the operation of the system, such as a list of execution processes and a list of library modules loaded for respective processes; a running kernel driver; pieces of network connection and data information for respective processes executed after the booting of the system; a list of important operating system files, and hash and digital signature information.

The external state extraction unit 212 extracts, from the outside of the sample execution system, the state of the sample execution system without operating in conjunction with an operating system. When a target system is operated on a virtual machine, the external state extraction unit 212 may extract external state information using a virtual machine file analysis method based on forensics for the memory file and the disk file of the virtual machine and a system state extraction method of operating in conjunction with a virtual machine management layer. Here, the forensics for the virtual machine memory file denotes a method and a series of procedures for converting items, for which an operating system stores data, stored in a file, in memory and uses the stored data during the running of the operating system, into respective data structures, and for recognizing and extracting a system call table, a descriptor table, a process list, a handle list, etc. using the converted data structures. Further, the forensics for the virtual machine disk file denotes a method and a series of related procedures for converting the data structure of an operating system file system using data stored in the virtual machine disk file and for extracting information about various types of files in the file system. When a target system is operated on an actual machine, the external state extraction unit 212 extracts state information using a method such as the tapping of hardware (Central Processing Unit (CPU) and buses).

That is, the state information extracted by the extraction unit 210 is given as follows.
List of execution processes and list of library modules loaded for respective processes
Running kernel driver
Pieces of network connection and data information for respective processes executed after the booting of the system
List of important operating system files, and hash and digital signature information
Virtual memory descriptor information
Memory maps of respective processes
Data on memory managed and used by kernels (for example, a system call table, a descriptor table, etc.)
Registry hives (Windows only)
Execution service or daemon

The analysis unit 220 performs static analysis and dynamic analysis of a malicious code sample. For this, the analysis unit 220 includes a static analysis unit 221 and a dynamic analysis unit 222.

The static analysis unit 221 analyzes and detects malicious code by determining whether a header in an execution file has been forged, whether a file extension or format has been forged, or whether the file has been searched for a suspicious character string, in a state in which a malicious code sample is present as a file in a disk without the malicious code sample being executed.

The dynamic analysis unit 222 tracks and records data on memory managed and used by kernels corresponding to a file, a registry, a process, and a network called while the malicious code sample is operating in the system after the malicious code sample has been executed (hereinafter also referred to as “kernel data”), and then analyzes the behavior of the malicious code and detects malicious behavior.

After the static analysis and dynamic analysis of the malicious code sample, the determination unit 230 extracts the state of the sample execution system 800 after the malicious code sample has been executed, compares the results of extraction with the state information extracted by the extraction unit 210 for respective items, calculates the level of threat of the malicious code sample based on the results of comparison, that is, system state change information, and detects whether the behavior of the malicious code has been conducted.

For this, the determination unit 230 includes a threat level calculation unit 231 and a malicious code determination unit 232.

In detail, in order for an execution file remaining after the malicious code has been executed to reveal the behavior thereof, a procedure for rebooting the system, executing a web browser, executing a program related to the sample, and falsifying system time may be performed before the state of the sample execution system 800 is extracted.

When the state of the sample execution system 800 is extracted after the malicious code sample has been executed, the determination unit 230 extracts the state of the same item as that when the state of the sample execution system 800 is extracted by the extraction unit 210 before the malicious code sample is executed. The comparison of the respective items is connected to a criterion for determining malicious behavior, such as registration as an initial execution process, the installation of a rootkit, registration as an initial execution kernel driver, and the collection of malicious commands based on automatic network connection.

The threat level calculation unit 231 calculates the level of threat of the malicious code sample using the static analysis information and dynamic analysis information, corresponding to the results of analysis by the analysis unit 220, and the system state change information.

The malicious code determination unit 232 determines whether the malicious code sample corresponds to malicious code, based on the level of threat of the malicious code sample calculated by the threat level calculation unit 231.

Next, the operating states of a sample execution system before a malicious code sample is executed, a sample execution system on which the malicious code sample is currently being executed, and a sample execution system after the malicious code sample has been executed will be described in detail with reference to FIGS. 3 to 5.

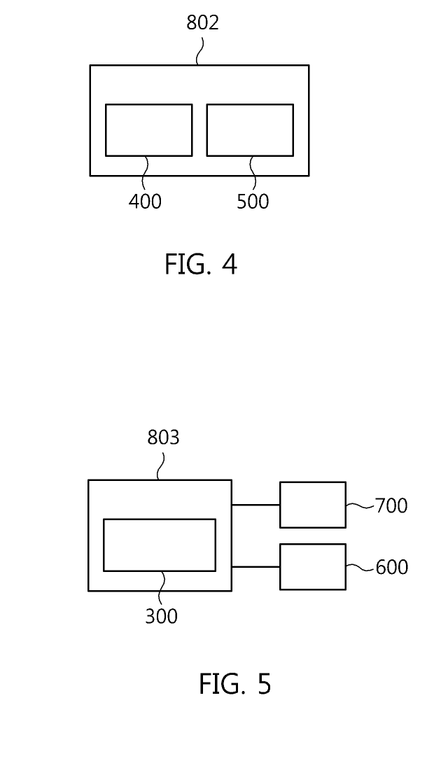

FIG. 3 is a reference diagram showing a method of extracting the state of a sample execution system before a malicious code sample is executed according to an embodiment of the present invention, FIG. 4 is a reference diagram showing a method of extracting the state of a sample execution system on which the malicious code sample is currently being executed according to an embodiment of the present invention, and FIG. 5 is a reference diagram showing a method of extracting the state of a sample execution system after the malicious code sample has been executed according to an embodiment of the present invention.

Referring to FIG. 3, the malicious code detection apparatus extracts the state of a sample execution system before a malicious code sample is executed 801, using a state analysis tool 300 installed in the sample execution system, a volatile state analysis tool 600, and a non-volatile state analysis tool 700.

Referring to FIG. 4, the malicious code detection apparatus extracts the static analysis information and the dynamic analysis information of a sample execution system 802 on which the malicious code sample is currently being executed, using a static analysis tool 400 and a dynamic analysis tool 500.

Referring to FIG. 5, the malicious code detection apparatus extracts the state of a sample execution system after the malicious code sample has been executed 803, using a state analysis tool 300 installed in the sample execution system, and a volatile state analysis tool 600 and a non-volatile state analysis tool 700.

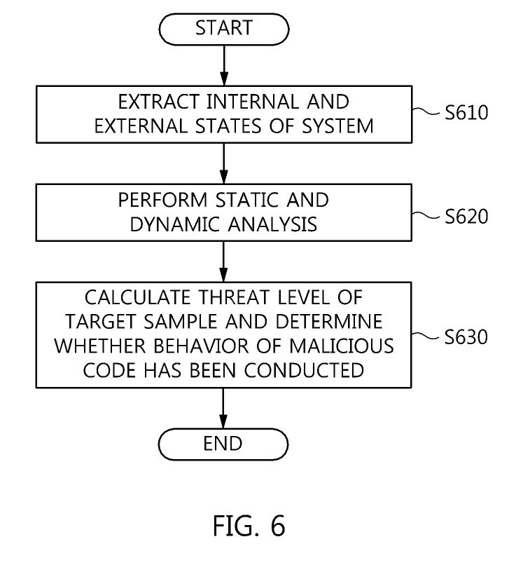

Next, a malicious code detection method will be described in detail with reference to FIG. 6.

FIG. 6 is a flowchart showing a malicious code detection method according to an embodiment of the present invention.

Referring to FIG. 6, the malicious code detection apparatus extracts the internal and external states of the sample execution system 800 before a malicious code sample is executed at step S610.

The internal state information extracted at step S610 includes state information that can be read from the inside of the system during the operation of the system, such as a list of execution processes and a list of library modules loaded for respective processes; a running kernel driver; pieces of network connection and data information for respective processes executed after the booting of the system; a list of important operating system files, and hash and digital signature information.

Further, the malicious code detection apparatus may extract external state information using a virtual machine file analysis method based on forensics for the memory file and the disk file of the virtual machine and a system state extraction method of operating in conjunction with a virtual machine management layer. When a target system is operated on an actual machine, the malicious code detection apparatus extracts state information using a method such as the tapping of hardware (CPU and buses).

The state information extracted by the malicious code detection apparatus at step S610 includes a list of execution processes and a list of library modules loaded for respective processes, a running kernel driver, pieces of network connection and data information for respective processes executed after the booting of the system, a list of important operating system files, and hash and digital signature information, virtual memory descriptor information, memory maps of respective processes, kernel data that is data on memory managed and used by kernels (for example, a system call table, a descriptor table, etc.), registry hives, and an execution service or a daemon.

The malicious code detection apparatus performs static analysis and dynamic analysis of the malicious code sample at step S620.

The malicious code detection apparatus performs static analysis by determining whether a header in an execution file has been forged, whether a file extension or format has been forged, or whether the file has been searched for a suspicious character string, in a state in which a malicious code sample is present as a file in a disk without the malicious code sample being executed.

The malicious code detection apparatus tracks and records pieces of kernel data corresponding to a file, a registry, a process, and a network called while the malicious code sample is operating in the system after the malicious code sample has been executed, and then dynamically analyzes the behavior of the malicious code.

After the static and dynamic analysis of the malicious code sample, the malicious code detection apparatus extracts the state of the sample execution system 800 after the malicious code sample has been executed, compares the results of extraction with the state information extracted by the extraction unit 210 for respective items, calculates the level of threat of the malicious code sample based on the results of comparison, that is, system state change information, and detects whether the behavior of the malicious code has been conducted at step S630.

In order for an execution file remaining after the malicious code has been executed to reveal the behavior thereof, a procedure for rebooting the system, executing a web browser, executing a program related to the sample, and falsifying system time may be performed before the state of the sample execution system 800 is extracted.

When the state of the sample execution system 800 is extracted after the malicious code sample has been executed, the malicious code detection apparatus extracts the state of the same item as that when the state of the sample execution system 800 is extracted by the extraction unit 210 before the malicious code sample is executed at step S610. The comparison of the respective items is connected to a malicious behavior determination criterion, such as registration as an initial execution process, the installation of a rootkit, registration as an initial execution kernel driver, and the collection of malicious commands based on automatic network connection.

The malicious code detection apparatus calculates the level of threat of the malicious code sample using the static analysis information and dynamic analysis information, corresponding to the results of analysis at step S620, and the system state change information. Next, the malicious code detection apparatus detects whether malicious behavior has been conducted based on the calculated level of threat of the malicious code sample.

In this way, the present invention overcomes a conventional malicious code analysis method based on static and dynamic analysis, and is capable of executing malicious code and extracting the change items of the system, thus making it possible to determine whether malicious behavior has been conducted even in a situation in which the entry point of the behavior conducted by the malicious code is not known.

In accordance with the present invention, the malicious code detection apparatus and method can overcome a conventional malicious code analysis method based on static and dynamic analysis, and is expected to greatly contribute to the improvement of the detection rate of malicious code in that it is possible to determine whether malicious behavior has been conducted, even in a situation in which the entry point of the behavior conducted by the malicious code is not known, by executing malicious code and extracting the change items of the system.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A malicious code detection method, comprising:
extracting a state of a sample execution system before a malicious code sample is executed;
performing static analysis and dynamic analysis of the malicious code sample;
after the malicious code sample has been executed, extracting a state of the sample execution system, comparing the results of extraction of the state with results of extraction of the state of the sample execution system before the malicious code sample is executed, and acquiring change information of the system; and
detecting whether malicious behavior of the malicious code sample has been conducted, using static analysis information and dynamic analysis information corresponding to results of performing static analysis and dynamic analysis and the system change information.

2. The malicious code detection method of claim 1, wherein extracting the state of the sample execution system comprises:
extracting an internal state of the sample execution system; and
extracting, from outside of the sample execution system, an external state of the sample execution system without operating in conjunction with an operating system.

3. The malicious code detection method of claim 2, wherein extracting the external state comprises:
when the sample execution system is operated on a virtual machine, extracting the external state using a virtual machine file analysis method based on forensics for a memory file and a disk file of the virtual machine and a system state extraction method of operating in conjunction with a virtual machine management layer.

4. The malicious code detection method of claim 1, wherein extracting the state of the sample execution system comprises extracting state information including at least one of a list of execution processes and a list of library modules loaded for respective processes; a running kernel driver; pieces of network connection and data information for respective processes executed after booting of the system; a list of important operating system files, and hash and digital signature information; virtual memory descriptor information; memory maps of respective processes; kernel data; registry hives; and an execution service or a daemon.

5. The malicious code detection method of claim 1, wherein performing the static analysis and the dynamic analysis comprises performing static analysis by determining whether a header in an execution file has been forged, whether a file extension or format has been forged, or whether the file has been searched for a suspicious character string, in a state in which the malicious code sample is present as a file in a disk without the malicious code sample being executed.

6. The malicious code detection method of claim 1, wherein performing the static analysis and the dynamic analysis comprises, after the malicious code sample has been executed, tracking and recording kernel data corresponding to a file, a registry, a process, and a network that are called while the malicious code sample is operating in the sample execution system, and then performing dynamic analysis.

7. The malicious code detection method of claim 1, wherein detecting whether the malicious behavior of the malicious code sample has been conducted comprises calculating a level of threat of the malicious code sample using the static analysis information, the dynamic analysis information, and the system change information, and detecting whether malicious behavior of the malicious code sample has been conducted, based on the calculated level of threat.

8. A malicious code detection apparatus, comprising:
an extraction unit for extracting a state of a sample executing system before a malicious code sample is executed;
an analysis unit for performing static analysis and dynamic analysis of the malicious code sample; and
a determination unit for comparing results of extraction of a state of the sample execution system after the malicious code sample has been executed, with results of extraction of the state of the sample execution system before the malicious code sample is executed, acquiring change information of the system, and detecting whether malicious behavior of the malicious code sample has been conducted, using results of analysis by the analysis unit and the system change information.

9. The malicious code detection apparatus of claim 8, wherein the extraction unit comprises:
an internal state extraction unit for extracting an internal state of the sample execution system; and
an external state extraction unit for extracting, from outside of the sample execution system, an external state of the sample execution system without operating in conjunction with an operating system.

10. The malicious code detection apparatus of claim 9, wherein the external state extraction unit is configured to, when the sample execution system is operated on a virtual machine, extract the external state using a virtual machine file analysis method based on forensics for a memory file and a disk file of the virtual machine and a system state extraction method of operating in conjunction with a virtual machine management layer.

11. The malicious code detection apparatus of claim 8, wherein the extraction unit extracts state information including at least one of a list of execution processes and a list of library modules loaded for respective processes; a running kernel driver; pieces of network connection and data information for respective processes executed after booting of the system; a list of important operating system files, and hash and digital signature information; virtual memory descriptor information; memory maps of respective processes; kernel data; registry hives; and an execution service or a daemon.

12. The malicious code detection apparatus of claim 8, wherein the analysis unit comprises a static analysis unit for performing static analysis by determining whether a header in an execution file has been forged, whether a file extension or format has been forged, or whether the file has been searched for a suspicious character string, in a state in which the malicious code sample is present as a file in a disk without the malicious code sample being executed.

13. The malicious code detection apparatus of claim 8, wherein the analysis unit comprises a dynamic analysis unit for, after the malicious code sample has been executed, tracking and recording kernel data corresponding to a file, a registry, a process, and a network that are called while the malicious code sample is operating in the sample execution system, and then performing dynamic analysis.

14. The malicious code detection apparatus of claim 8, wherein the determination unit uses a malicious behavior determination criterion corresponding to at least one of registration as an initial execution process, installation of a rootkit, registration as an initial execution kernel driver, and collection of malicious commands via automatic network connection, upon comparing the results of extraction of the state of the sample execution system after the malicious code sample has been executed, with the results of extraction of the state of the sample execution system before the malicious code sample is executed.
